(19) United States
(12) Patent Application Publication
(10) Pub. No.: US 2024/0233298 A1
(43) Pub. Date: Jul. 11, 2024

(54) SYSTEMS AND METHODS FOR COLLABORATION ON THREE-DIMENSIONAL DIGITAL MEDIA DEVELOPMENT

(71) Applicant: AQUENT LLC, Boston, MA (US)

(72) Inventors: Daniel Perez, Cumming, GA (US); John H. Chuang, Brookline, MA (US)

(73) Assignee: AQUENT LLC, Boston, MA (US)

(21) Appl. No.: 18/405,130

(22) Filed: Jan. 5, 2024

Related U.S. Application Data
(60) Provisional application No. 63/478,739, filed on Jan. 6, 2023.

(51) Int. Cl. G06T 19/20; G06T 13/40; G06V 20/70

(52) U.S. Cl. CPC G06T 19/20; G06T 13/40; G06V 20/70; G06T 2219/2016

(57) ABSTRACT

The present invention relates to a system and method for collaborating among a plurality of users on three-dimensional (3D) digital media development. In some embodiments, these systems and methods including a proofing/annotation tool to support 3D digital media and to allow content creators focused on gaming, movies and metaverse development to benefit from its collaboration and workflow tools. The proofing/annotation tool of the present invention allows a user to view digital content (e.g., an image, document, video) and add markup and comments that overlay the underlying digital content. Thus, the present invention offers the capabilities and features needed to support collaboration among team members on the development of three-dimensional (3D) digital media, such as gaming, movies, metaverse, etc.

### CROSS-REFERENCE TO RELATED APPLICATIONS

This application is a Non-Provisional of Provisional (35 USC 119(e)) of U.S. Application Ser. No. 63/478,739, entitled “SYSTEMS AND METHODS FOR COLLABORATION ON THREE-DIMENSIONAL DIGITAL MEDIA DEVELOPMENT”, filed Jan. 6, 2023, the entire contents of which are incorporated herein by reference.

### BACKGROUND OF THE INVENTION

It is appreciated that conventional methods and applications for collaborative development are limited to text documents or two-dimensional data. These methods and applications do not have the capabilities and features needed to support collaboration among team members on the development of three-dimensional (3D) digital media, such as gaming, movies, metaverse, etc.

Three-dimensional digital media has unique characteristics that require a different approach than what is used for traditional digital files. First, like a web page, 3D digital media is typically stored as a collection of files rather than an individual file. The primary components may include a model file (e.g., the 3D framework that provides the “shape” of one or more objects) and one or more textures such as image or video files that provide the “skin” that may be laid on top of the model's surface. The model file typically contains hard-coded references or paths to the textures that are designed to work with it. Therefore, in order to allow a user to upload 3D digital media, the application must provide a mechanism for allowing the user to upload each of the additional files and then store them in such a way that the internal pointers between the model and one or more textures will still be valid. Second, as 3D content will typically be used within the context of some external environment (e.g., a conference room in the metaverse), the application must provide lighting and perspective controls that would normally be part of the environment to which the 3D object is eventually deployed.

Accordingly, there exists a need for systems and methods to support collaboration on three-dimensional digital media development including its unique characteristics.

### SUMMARY OF THE INVENTION

In some aspects described herein, a system is provided for collaboration among a plurality of users on three-dimensional digital media development comprising: an interface comprising a plurality of display elements, the display elements being configured to: display a control enabling a first one of the plurality of users to select a file containing at least one three-dimensional object to upload; receive information for at least one review including an assignment of the at least one three-dimensional object to the at least one review; display a control enabling a second one of the plurality of users to perform one or more operations on the at least one three-dimensional object, the operations including rotating and scaling; and receive one or more annotations on one or more locations of the at least one three-dimensional object.

In some embodiments, the display elements are further configured to: display a control enabling the second one of the plurality of users to select a file containing at least one three-dimensional animation to upload; display a control enabling the second one of the plurality of uses to perform one or more operations on the at least one three-dimensional animation, the operations including rotating, scaling, starting, stopping, and resuming the at least one three-dimensional animation; receive an assignment of the at least one three-dimensional animation to the at least one review; and receive one or more annotations at one or more locations on the at least one three-dimensional animation at one or more instances in time.

In some embodiments, the display elements are further configured to: receive information for the at least one project; and receive information for the at least one review. In some embodiments, the information for the at least one project includes at least one of the group comprising a title, a status, budgeted expenses, revenue, expenses, a code, a description, estimated revenue, the name of a creator of the at least one project, a planned start date, an indicator of whether the at least one project is on budget, a due date, an identifier, an indicator of whether the at least one project is on schedule.

In some embodiments, the information for the at least one review includes at least one of the group comprising a name, a type, a name of an owner of the at least one review, a status, a start date, an end date, an indicator of whether the at least one review is automatically completed, and one or more predecessors.

In some embodiments, the at least one review comprises a plurality of stages and the display elements are further configured to: receive information for at least one of the plurality of stages, the information including one or more of the group comprising a name, a due date, a name of an owner of the at least one of the plurality of stages, an indicator of whether to notify the owner of a response for the at least one of the plurality of stages, one or more email addresses designated to receive that at least one of the plurality of stages; and notify the owner of the response for the at least one of the plurality of stages.

In some embodiments, the at least one three-dimensional object comprises a plurality of versions and the plurality of display elements is further configured to: display a first one the plurality of versions of the at least one three-dimensional object on a screen with a second one of the plurality of versions of the at least one three-dimensional object; and compare the first one of the plurality of versions of the at least one three-dimensional object with the second one of the plurality of versions of the at least one three-dimensional object.

In some embodiments, the plurality of display elements is further configured to: receive one or more comments on one or more locations of the three-dimensional object. In some embodiments, the plurality of display elements is further configured to: receive one or more comments on the one or more locations of the three-dimensional animation at the one or more instances in time. In some embodiments, the plurality of display elements is further configured to: receive an approval of the three-dimensional object from the second one of the plurality of users.

In other aspects described herein, a method is provided for collaboration among a plurality of users on three-dimensional digital media development comprising: displaying a control enabling a first one of the plurality of users to select a file containing at least one three-dimensional object to upload; receiving information for at least one review including an assignment of the at least one three-dimensional object to the at least one review; displaying a control enabling a second one of the plurality of users to perform one or more operations on the at least one three-dimensional object, the operations including rotating and scaling; and receiving one or more annotations on one or more locations of the at least one three-dimensional object.

In some embodiments, the method further comprises: displaying a control enabling the second one of the plurality of users to select a file containing at least one three-dimensional animation to upload; displaying a control enabling the second one of the plurality of uses to perform one or more operations on the at least one three-dimensional animation, the operations including rotating, scaling, starting, stopping, and resuming the at least one three-dimensional animation; receiving an assignment of the at least one three-dimensional animation to the at least one review; and receiving one or more annotations at one or more locations on the at least one three-dimensional animation at one or more instances in time.

In some embodiments, the method further comprises: receiving information for the at least one project; and receiving information for the at least one review. In some embodiments, the information for the at least one project includes at least one of the group comprising a title, a status, budgeted expenses, revenue, expenses, a code, a description, estimated revenue, the name of a creator of the at least one project, a planned start date, an indicator of whether the at least one project is on budget, a due date, an identifier, an indicator of whether the at least one project is on schedule.

In some embodiments, the information for the at least one review includes at least one of the group comprising a name, a type, a name of an owner of the at least one review, a status, a start date, an end date, an indicator of whether the at least one review is automatically completed, and one or more predecessors.

In some embodiments, the at least one review comprises a plurality of stages, and the method further comprises: receiving information for at least one of the plurality of stages, the information including one or more of the group comprising a name, a due date, a name of an owner of the at least one of the plurality of stages, an indicator of whether to notify the owner of a response for the at least one of the plurality of stages, one or more email addresses designated to receive that at least one of the plurality of stages; and notifying the owner of the response for the at least one of the plurality of stages.

In some embodiments, the at least one three-dimensional object comprises a plurality of versions, and the method further comprises: displaying a first one the plurality of versions of the at least one three-dimensional object on a screen with a second one of the plurality of versions of the at least one three-dimensional object; and comparing the first one of the plurality of versions of the at least one three-dimensional object with the second one of the plurality of versions of the at least one three-dimensional object.

In some embodiments, the method further comprises: receiving one or more comments on one or more locations of the three-dimensional object. In some embodiments, the method further comprises receiving one or more comments on the one or more locations of the three-dimensional animation at the one or more instances in time.

In some embodiments, the method further comprises: receiving an approval of the three-dimensional object from the second one of the plurality of users.

In another aspect of the present invention, a non-transitory computer-readable media is provided comprising instructions that, when executed by one or more processors on a computing device, are operable to cause the one or more processors to execute the methods described above and herein.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence is intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows an exemplary page of an exemplary interface displaying a three-dimensional object;

FIG. 2 shows an exemplary page in an exemplary interface displaying a three-dimensional object with a comment from a user;

FIG. 3 shows an exemplary page of an exemplary interface displaying a summary of an exemplary project;

FIG. 4A shows an exemplary page of an exemplary interface displaying information to create a review of an exemplary project;

FIG. 4B shows an exemplary page of an exemplary interface displaying various options for autocomplete review of an exemplary project;

FIG. 5 shows a portion of an exemplary page of an exemplary interface displaying additional information to create multiple stages of review of an exemplary project;

FIG. 6 shows another portion of an exemplary page of an exemplary interface displaying information for a subsequent stage of review of an exemplary project;

FIG. 7 shows an exemplary page of an exemplary interface displaying different versions of a file to be reviewed;

FIG. 8 shows an exemplary display of two different versions of a mobile image;

FIG. 9 shows an exemplary page that may be displayed when the review type is set to request approval.

FIG. 10 shows a Reviews tab that may be selected by a user on an exemplary page of an exemplary interface;

FIG. 11 shows an exemplary page on an exemplary interface for duplicating an existing review;

FIG. 12 shows an exemplary page on an exemplary interface for modifying information for tasks;

FIG. 13 shows an exemplary page on an exemplary interface for uploading a review file;

FIG. 14 shows an exemplary page on an exemplary interface for specifying reviewers and notification options;

FIG. 15 shows an exemplary page on an exemplary interface for an approval type review that is configured for document signing;

FIG. 16 shows an exemplary page on an exemplary interface for enabling digital signatures;

FIG. 17 shows an exemplary page on an exemplary interface for signing by a user who approves or rejects a review item;

FIG. 18 shows an exemplary page on an exemplary interface for a user to provide an optional comment with a signature;

FIG. 19A shows an exemplary page on an exemplary interface for uploading one or more files from a user's computer;

FIG. 19B shows an exemplary page on an exemplary interface for adding or editing a version label;

FIG. 20 shows an exemplary page on an exemplary interface for uploading animated GIF files for review and annotation;

FIG. 21 shows an exemplary page on an exemplary interface for importing pdf annotations from a pdf reader;

FIG. 22 shows an exemplary page on an exemplary interface for adding a stage to a multi-stage review;

FIG. 23 shows an exemplary page on an exemplary interface for creating a new version of a review file;

FIG. 24 shows an exemplary page on an exemplary interface for allowing a user to choose whether to activate a review in an inactive state;

FIG. 25 shows an exemplary page on an exemplary interface for selecting a version of a file to review;

FIG. 26 shows an exemplary page on an exemplary interface including a magnifying glass symbol that may be used to select a desired version of a document;

FIG. 27 shows an exemplary page on an exemplary interface for comparing two versions of a file;

FIG. 28 shows an exemplary page on an exemplary interface for selecting two versions of a file to compare;

FIG. 29 shows an exemplary page on an exemplary interface tracking comment progress of a review;

FIG. 30 shows an exemplary page on an exemplary interface for updating an annotation;

FIG. 31 shows an exemplary page on an exemplary interface for sorting comments;

FIG. 32 shows an exemplary page on an exemplary interface for filtering comments;

FIG. 33 shows an exemplary page on an exemplary interface for displaying the identifiers of users who are currently viewing a Review file;

FIG. 34 shows an exemplary page on an exemplary interface showing that pages with comments are highlighted;

FIG. 35 shows an exemplary page on an exemplary interface for viewing all comments multi-page file at once;

FIG. 36 shows an exemplary page on an exemplary interface for ordering selections;

FIG. 37 shows an exemplary page on an exemplary interface for monitoring Review status and Reviewer progress;

FIG. 38 shows an exemplary page on an exemplary interface for sending a reminder to reviewers to perform their reviews;

FIG. 39 shows an exemplary page on an exemplary interface for listing different categories in a Review; and

FIG. 40 shows an exemplary page on an exemplary interface for integrating a review into a project template.

### DETAILED DESCRIPTION OF INVENTION

The present invention includes systems and method for collaboration on three-dimensional digital media development. In some embodiments, these systems and methods include a proofing/annotation tool, which is an essential component of its project management solution for creative teams. Creative teams need a way to share digital media with collaborators, receive and track their feedback and manage approval workflows. The present invention supports 3D digital media within its proofing/annotation tool and allows content creators focused on gaming, movies and metaverse development to benefit from its collaboration and workflow tools.

The proofing/annotation tool of the present invention allows a user to view digital content (e.g., an image, document, video) and add markup and comments that overlay the underlying digital content. For example, a user may draw a circle around a logo that is part of an image and add a comment concerning some aspect of its presentation. In some embodiments, the proofing/annotation tool may save the position and size of the circle as well as its relative position to the underlying image. When other users view the image, they may see this circle and the associated comment displayed in the same position where the original user placed it. In some embodiments, the annotation/proofing tool may also provide various controls (e.g., zoom, paging, panning, scrolling) to enable users to view the media and add their markup.

In a project management solution of one embodiment of the present invention, proofing/annotation is an essential component in the workflow of a project. While a creative team is working on a deliverable project, there are typically several rounds of required collaboration and review before the deliverable project is finalized. These rounds of proofing/annotation may be linked together with other tasks that may be required to complete the project and ensure it fits within the desired schedule.

Some embodiments of the present invention allow users to upload three-dimensional (3D) digital media, configure the presentation characteristics for the 3D media, view 3D digital media including the ability to change the scale, viewing position and any animation and add markup comments to the 3D digital media and retain the position (e.g., the x/y/z coordinates) and timing (in relation to any animation) of the markup.

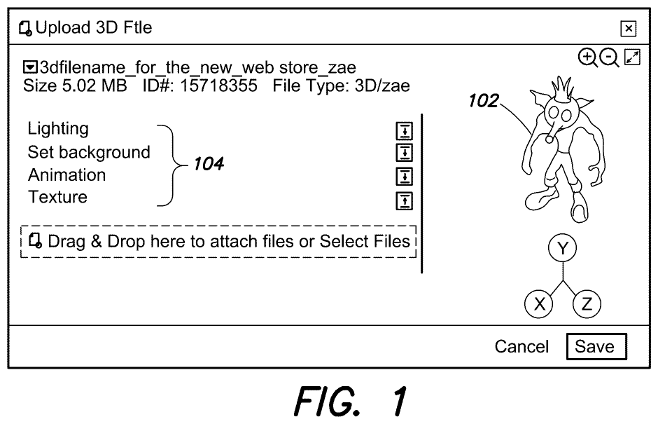

FIG. 1 shows an exemplary page in an exemplary interface of the present invention displaying a three-dimensional object 102. This page may be used to upload a three-dimensional object. The page includes information on the file containing the three-dimensional object such as its size, its identification number and its type. The page may also include various controls 104 to set the lighting, the background, the animation, and the texture. The page may also include an area to drop or select files such as the file containing the displayed three-dimensional object in FIG. 1. The page may also include controls to zoom in and out of the displayed three-dimensional object. The page may also include a control to save modifications that are made to the three-dimensional object or its associated data and to cancel any such modifications without saving them.

In some embodiments, the present invention may include an annotation component allowing users who may be asked to provide feedback on the 3D object to view, rotate and scale the object. Optionally, the user may provide feedback on one or more specific aspects of the object by dropping a comment on the object. In some embodiments, the present invention may track the object's position, rotation, and scale. In some embodiments, the three-dimensional object may be animated. In those embodiments, the present invention may also capture a timestamp in an animation loop where the comment is dropped. When users later view the comment, the present invention may automatically rotate and pan the object so that the exact position and point in time where the comment is added are visible. This functionality may be incorporated into a review tool of the present invention to enable users to incorporate 3D digital media reviews into complex workflows and multi-stage approvals. As the number of creative teams working on 3D digital media increases with the growth of the metaverse, the present invention will allow teams to incorporate these review cycles into their work process.

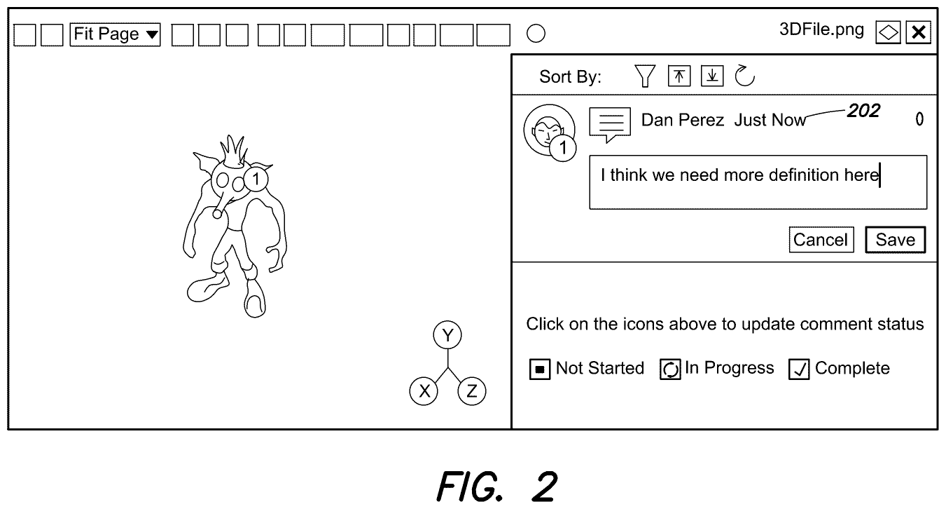

FIG. 2 shows an exemplary page in an exemplary interface of the present invention displaying a three-dimensional object with a comment 202 from a user. This page may be used to edit and place comments or annotations on a three-dimensional object. The page includes a comment from a user on a particular location of the three-dimensional object indicating that more definition may be needed.

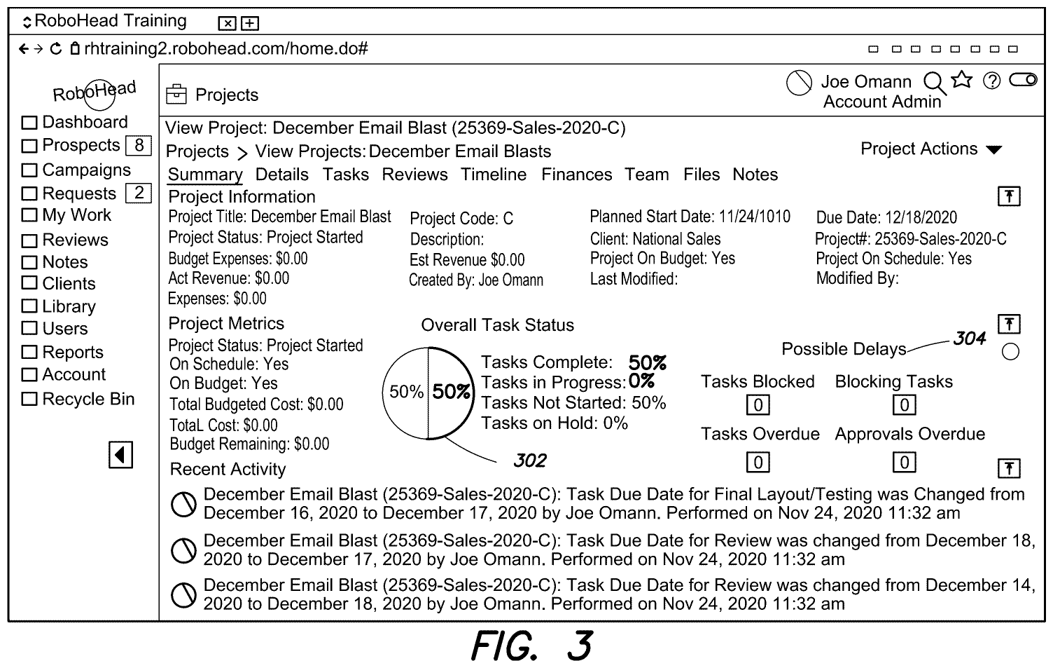

FIG. 3 shows an exemplary page of an exemplary interface of the present invention displaying a summary of an exemplary project. In some embodiments, the page includes various types of information for a project including one or more of the following: a title, a status (e.g., started, completed), budgeted expenses, revenue, expenses, a code, a description, estimated revenue, the name of a person who created the project, the name of the account administrator, a planned start date, a name of a client, an indicator as to whether the project is on budget (e.g., yes, no), a due date, a project number, an indicator as to whether the project is on schedule (e.g., yes, no), the name of a person who modified the project, etc.

In some embodiments, the page includes various types of metrics for a project including one or more of the following: a project status (e.g., started, completed), an indicator as to whether the project is on budget (e.g., yes, no), an indicator as to whether the project is on schedule (e.g., yes, no), total budgeted cost, total cost, budget remaining, a status indicator 302 (e.g., a pie chart showing percentages of tasks complete, tasks in progress, tasks not started, tasks on hold), and indicators of possible delays 304 (e.g., tasks blocked, blocking tasks, tasks overdue, approvals overdue). In some embodiments, the page includes a list of recent activities such as changes in due dates.

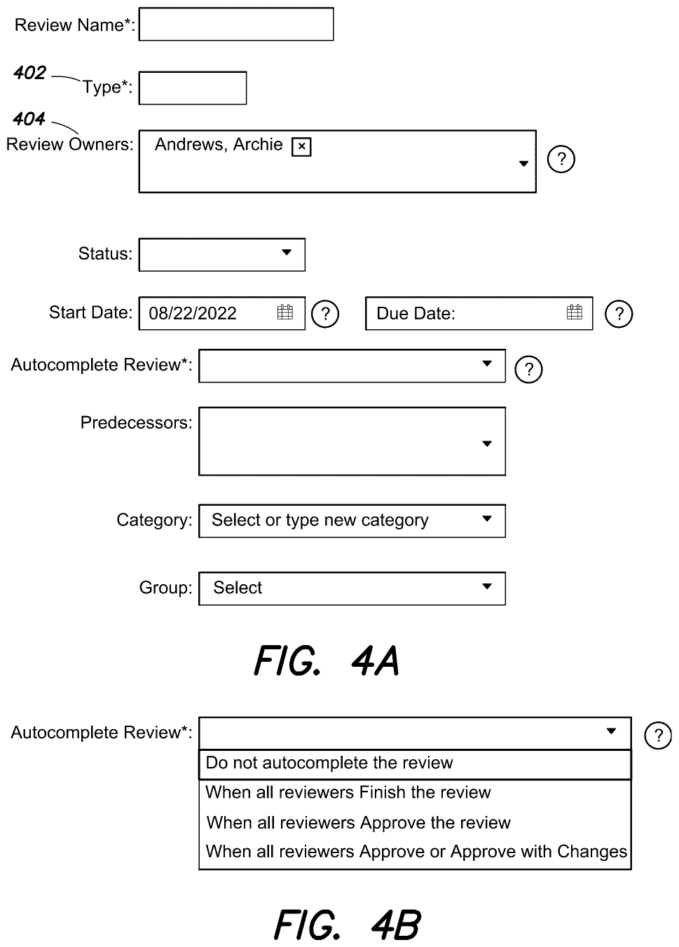

FIG. 4A shows a portion of an exemplary page of an exemplary interface of the present invention displaying information to create a review of an exemplary project. In some embodiments, the page includes various types of information for a review of a project including one or more of the following: review name, type of review (e.g., requesting comments and feedback, request approval), name of the owner of the review, the status of the review (e.g., not started), the start and end dates of the review, an indicator as to whether the review should be automatically completed, and a list of predecessors (e.g., white paper, layout). In some embodiments, the various types of information for a review may be modified from their original values.

The Review Name may be the name of the item a user is uploading for review. Exemplary review names include “New company home page”, “January New Business brochure”, or “New Logo Design.” In some embodiments, the Review Name may be searchable by others and therefore, a user may consider adopting a standard naming convention for reviews to make searching easier for other users in the same organization or company.

The Review Type 402 may include Comments/Feedback or Request Approval. The Comments/Feedback type may generally be used for initial review versions to capture reviewers' feedback via comments only. The Request Approval type may be used later in the review process when a project is nearing completion and requires approval from a client, department, or user. A series of buttons may appear on a reviewer's page to approve, reject, or approve the item with changes.

The Review Owners field 404 may include other users who are designated to receive email notification based on various activities (e.g., Reviews due today, overdue Reviews, approval received). The users listed on this Review Owners field may toggle quickly to “Reviews I own” on the Reviews tab. In some embodiments, users may be added to the Review Owners field on the view/modify Review page.

The Review Status field may contain one or more of the following: Not Started, In Progress, Complete, and On Hold. The Not Started value indicates that the review status is not yet ready to begin. The In Progress value indicates that one or more items have been sent to reviewers for comments or approval. In some embodiments, a Review having the value Not Started will automatically update to In Progress when the first comment is made. The Complete value indicates that the Review is finished (e.g., all comments and/or approvals have been received, and the Review is closed to further comments or approvals). In some embodiments, the Request Approval type of Review may have one or more of the following three status values: Complete and Approved, Complete and Approved with Changes, Complete and Denied. The On Hold value indicates that the review has been activated but has been delayed for some reason. With this status, all notifications for the review are deactivated until it is set back to a value of Not Started or In Progress.

The Date Range field may include a Start Date and a Due Date. The Start Date specifies the first day that the Review is available for comments or approval (e.g., when the Review will first be available to reviewers). The Due Date specifies the date by which all feedback/approvals are required. In some embodiments, the Review will still be available to reviewers even if the Due Date has past until the status is marked Complete.

The Autocomplete Review field may contain one or more of the following options: blank, Do Not Autocomplete, When all reviewers Finish the Review, When all reviewers Approve the Review, or When all reviewers Approve or Approve with Changes. In some embodiments, the value for the Autocomplete Review field may not be saved and therefore, may need to be set on each Review. FIG. 4B illustrates the various options for an exemplary drop-down menu for the Autocomplete Review field 406.

The Predecessors field my lists tasks upon which a review may be dependent. Thus, a user may use the Predecessors field to integrate the review into a task workflow. The Category field may designate a custom category for organization on the Schedule tab. In some embodiments, this field is optional. The Group field may designate a custom group for organization on the Schedule tab. In some embodiments, the Group field is optional.

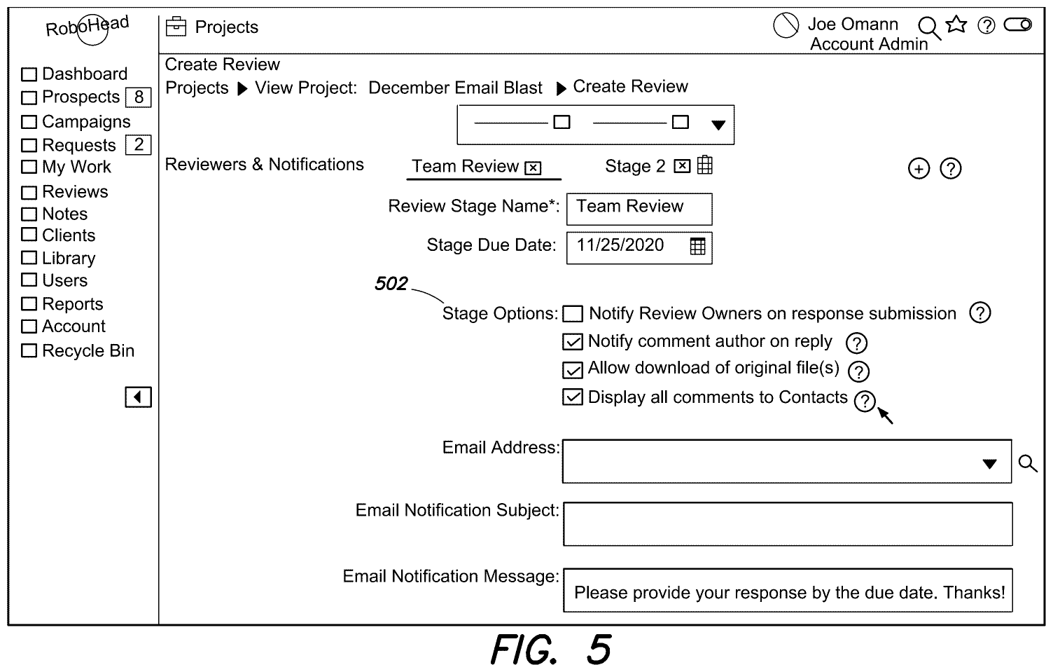

FIG. 5 shows another portion of an exemplary page of an exemplary interface of the present invention displaying additional information to create multiple stages of review of an exemplary project. In some embodiments, this portion of the page includes various types of information for a review of a project including one or more of the following: review stage name, a due date for the stage of the review, various stage options 502 (e.g., indicators as to whether to notify review owners of a submission of a response, whether to notify an author of a comment as to a reply, whether to allow a download of one or more original files, whether to display comments to contacts), a list of email addresses to receive the review stage, a notification subject for an email, and a notification message for an email (e.g., requesting a response by the due date). In some embodiments, the various types of information for a stage of a review may be modified from their original values.

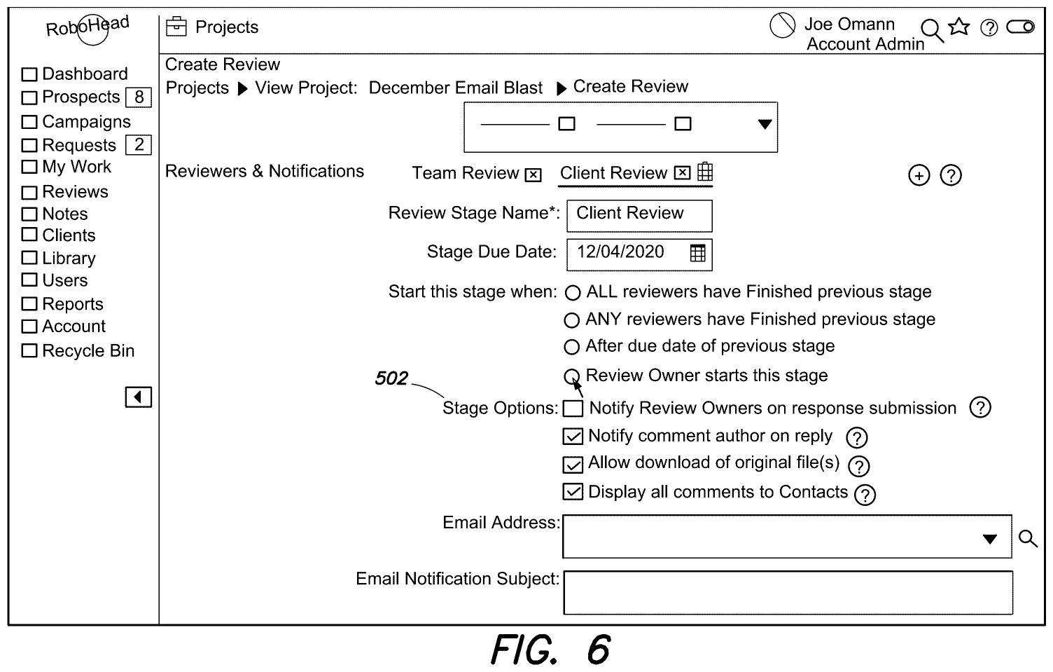

FIG. 6 shows another portion of an exemplary page of an exemplary interface of the present invention displaying information for a subsequent stage of a review of an exemplary project. In some embodiments, this portion of the page includes various types of information regarding a subsequent stage of review including one or more of the following: review stage name, stage due date, an indication of when to start this stage (e.g., after all reviewers have finished the previous stage, after any reviewers have finished the previous stage, after the due date of the previous stage, after the owner of the review starts this stage), stage options 502 (e.g., indicators as to whether to notify review owners of a submission of a response, whether to notify an author of a comment as to a reply, whether to allow a download of one or more original files, whether to display comments to contacts), a list of email addresses to receive the review stage, a notification subject for an email, and a notification message for an email (e.g., requesting a response by the due date). In some embodiments, each stage can have its own users, email notification subject, message, etc. In some embodiments, files associated with a review stage may be uploaded from different sources including a user's computer, a web site identified by a Universal Resource Locator (URL), zip and extract files, projects, libraries, etc.

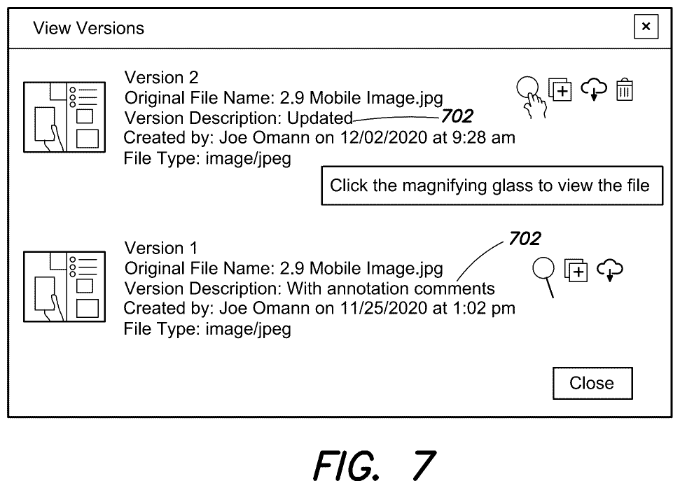

In some embodiments, multiple versions of an object (e.g., a three-dimensional figure) may be designated for review. FIG. 7 illustrates an exemplary page of an exemplary interface of the present invention displaying different versions of a file to be reviewed. In some embodiments, various types of information about each version may be displayed including, for example, a file name, a version description 702 (e.g., updated, with annotation comments), the name of the person who created the version for review, file type (e.g., image/jpeg).

In some embodiment, different versions of an object (e.g., mobile image, a three-dimensional figure) may be compared. FIG. 8 illustrates an exemplary display of two different versions of a mobile image 802 on the system of the present invention. In some embodiments, an annotation panel associated with the objects being compared may be selectively displayed.

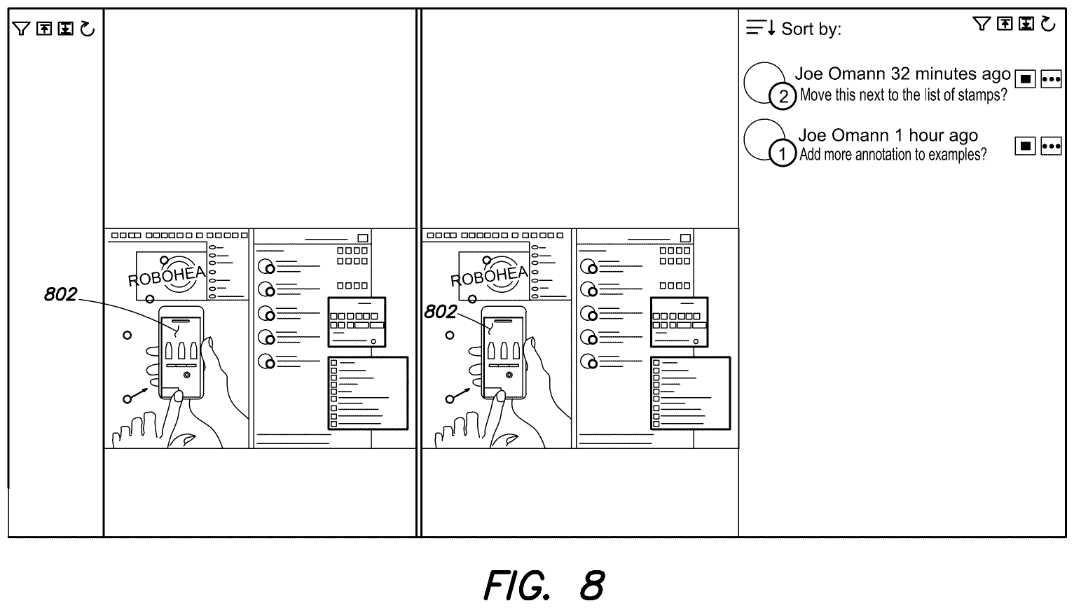

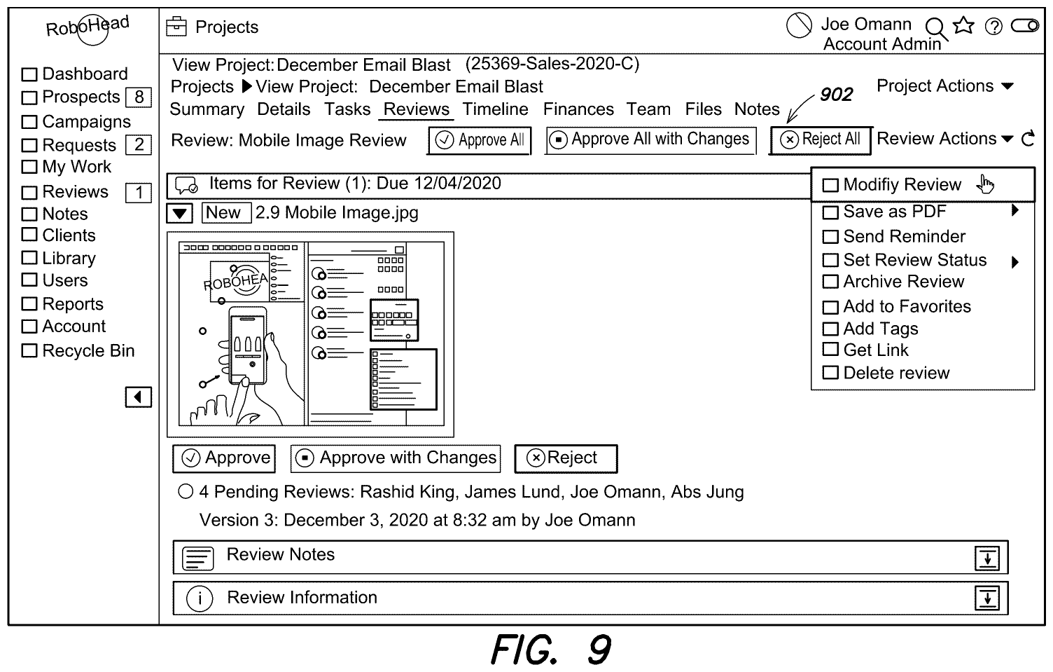

In some embodiments, the review type (e.g., requesting comments and feedback, request approval) may be changed. FIG. 9 illustrates an exemplary page that may be displayed when the review type is set to “request approval.” In some embodiments, various options 902 may be displayed including one or more of the following: approve all, approval all with changes, reject all. Various options may be displayed on a drop-down menu under a “review actions” tab including one or more of the following: modify review, save as PDF, send reminder, set review status, archive review, add to favorites, add tags, get link and delete review.

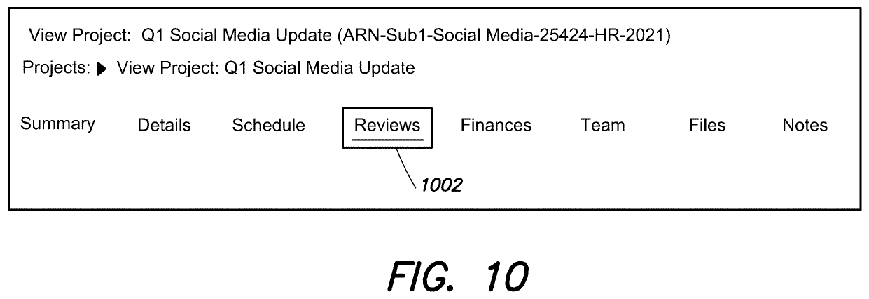

In some embodiments of the present invention, a user may create a review in one or more of the following ways: manually create a review from the Reviews tab or Schedule tab, duplicate an existing Review, or add a Review from a project template. For example, a user may navigate to the Project in which a review is desired to be created. Next, a user may select the Reviews tab 1002 as shown by the exemplary page of the exemplary interface of FIG. 10. Next, a user may select the “New Review” option that appears upon selection of the Reviews tab.

Alternatively, a user may create a new Review by first selecting the Schedule tab from the exemplary page of the exemplary interface of FIG. 10. Next, a user may select the New Review option that appears in the Calendar and Gantt Chart views upon selection of the Reviews tab. Upon selection of the New Review option, a Create Review page, such as those shown in FIG. 4A, 5, or 6 may be displayed.

Alternatively, a user may create a review by duplicating an existing review by clicking on the “Actions” pulldown menu for a review and selecting the Duplicate Review option 1102, as illustrated in FIG. 11. In some embodiments, only select users such as an account administrator, a user with Manage permissions to a project or a Review Owner may create a review by duplicating an existing review.

Alternatively, a user may create a review by applying a template that had previously been created. To apply a template to a specific review process for a particular type of project, a user may navigate to the Projects page, select the Actions drop-down menu, and select the Apply Template option from the drop-down menu. After selection of the Apply Template option, a page will be displayed from which a user may select items to import from the template. A user may then select a template and may either shift the project dates or set the dates manually.

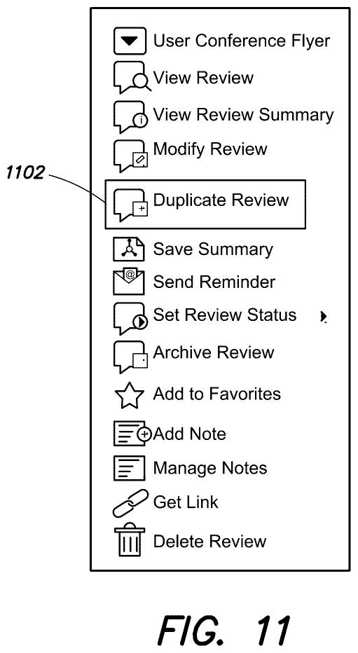

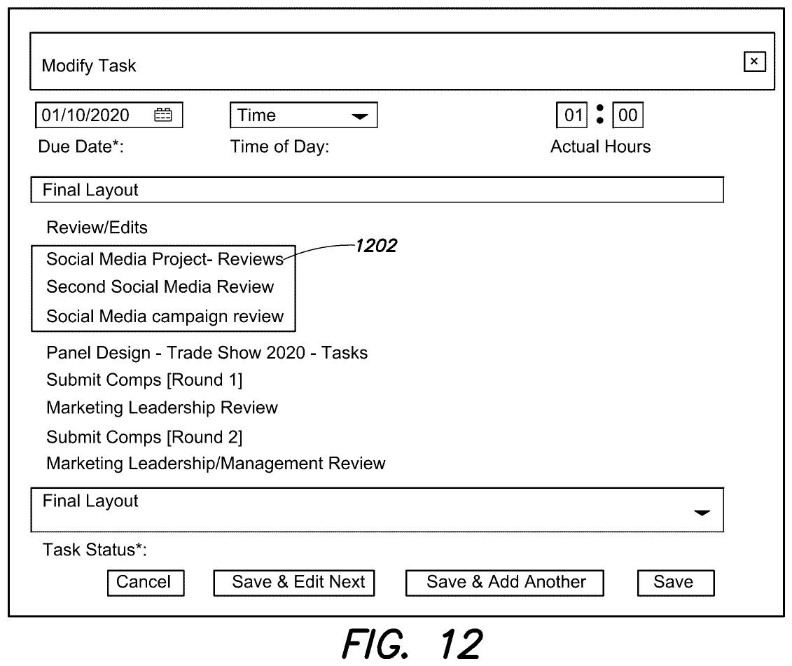

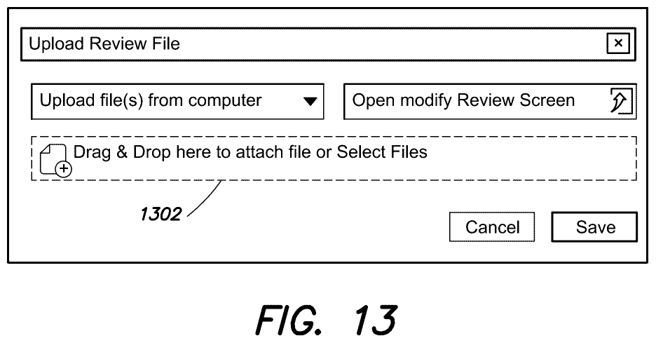

In some embodiments, reviews may be added to task schedules by predecessor Tasks for the Review (i.e., tasks that must be completed before activation of the Review) or by setting the Review as a predecessor to other Tasks. In some embodiments, Reviews are in a different section that other Tasks in a Project or other Project Tasks in a Campaign. FIG. 12 illustrates an exemplary page in an exemplary interface for modifying information for tasks, such as Social Media Project Review 1202. FIG. 13 illustrates an exemplary page in an exemplary interface for uploading a review file. In some embodiments, when a user completes a task that identified as a predecessor to a review, the user may be prompted to add a file to the review in the Drag and Drop/select file section 1302, thereby saving time and steps by not having to modify the Review separately.

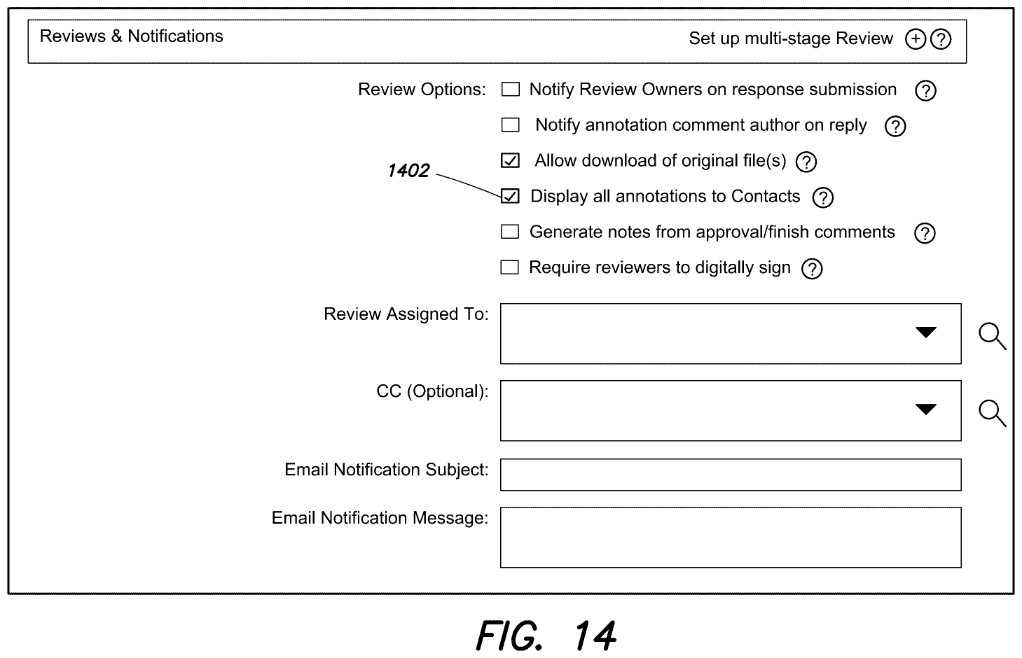

Some embodiments of the present invention include reviewers and notification options. FIG. 14 illustrates an exemplary page in an exemplary interface for specifying these reviewers and notification options. The Notify Review Owners on response submission indicates, when checked, that the Review Owner will receive an email each time a reviewer creates a comment or submits their approval for the Review. In some embodiments, the Notify Review Owners on response submission may be used in connection with Review Event Notification Preferences (e.g., Review Feedback Received, Review Approval Received and Review Marked As Finished).

The Notify comment author on reply field indicates, when checked, that an e-mail will be sent to anyone who makes a comment in the review when someone responds to the comment. The Allow download of original file(s) field, when checked, indicates that a reviewer may download a clean copy of any file that has been uploaded for Review (e.g., a high-resolution JPG file). The Display all annotations to Contacts field 1402, when checked, indicates that all reviewers may see each comments from all the other reviewers and may respond to those comments. In some embodiments, this option is the default when if a Review is sent only to internal (e.g., non-Contact) reviewers. The Generate Notes from Approval/Finish Comments field, when checked, indicates that Approval and Finish comments will be added to the review as separate notes. If this field is unchecked, these will appear in the review log but cannot be replied to and will not generate separate notifications. The Require all Reviewers to Digitally Sign, when checked, requires all reviewers to digitally sign all files in the review.

Lists of email addresses for the users to which the Review is sent may be listed in the Review Assigned To field. In some embodiments, a user may send a Review to any number of other users. In some embodiments, a user may click the magnifying glass icon to the right of the Review Assigned to field to select users by first or last name or to select a Review Group of users. In some embodiments, Account Administrators and Project Managers may have the ability to create new Review Groups on the main left-hand Users tab. The CC field may be used to list users who are selected to see the Review but are not required to participate in the Review. In some embodiments, users listed in the CC field may create annotations, but may not approve or reject review items. In some embodiments, responses from users listed in the CC field may not be considered in Sequential Reviews. In some embodiments, an Account Admin may reset a Review Notification template to a default setting or add a variable tot eh Review Notification template.

The Email notification subject contains the text that will appear in the Subject line of any notification emails that are sent to any reviewer. The Email notification message contains the message body that will appear in any notification email sent to any reviewer. In some embodiments, a Review Signature, or default message (e.g., a user's name and contact information, a generic message) may be specified in the Email notification message field, thereby enabling the Reviewers to know the user who sent the Review. In some embodiments, the contents of the Email notification message field may also be added to the Review as a general note.

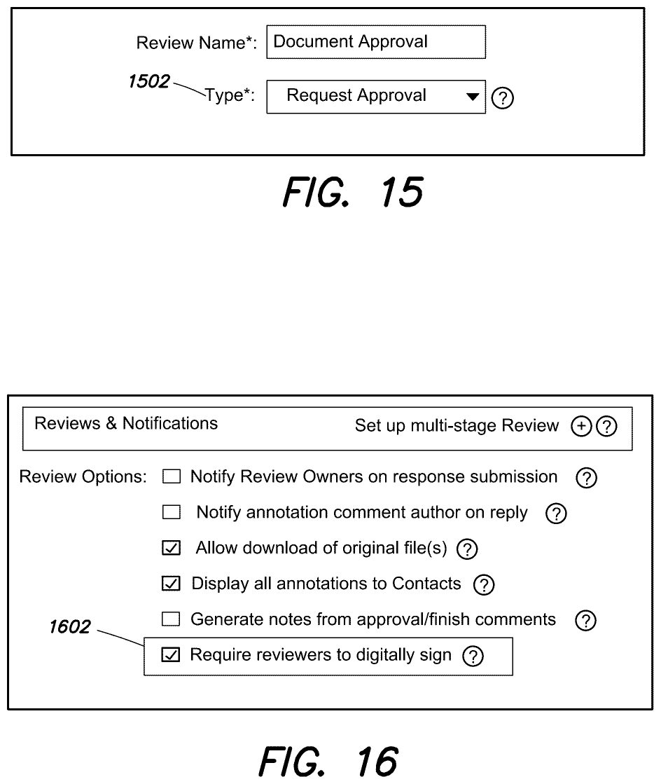

In some embodiments, an Approval type review 1502 may be configured for document signing, as illustrated in FIG. 15. In some embodiments, digital signatures 1602 may be enabled as illustrated in FIG. 16. A user who approves or rejects a review item, may be asked to sign, as illustrated in FIG. 17. In some embodiments, when signatures 1702 are enabled on a review, users will be required to sign for all approval types, including Approved, Approved with Changes, and Rejected. In some embodiments, a user may sign anywhere on the document. In some embodiments, a document may have designated lines for adding signatures. When signing, a user may also an optional comment 1802 along with your signature, as illustrated in FIG. 18. In some embodiments, a user may configure a personal signature by modifying a user profile.

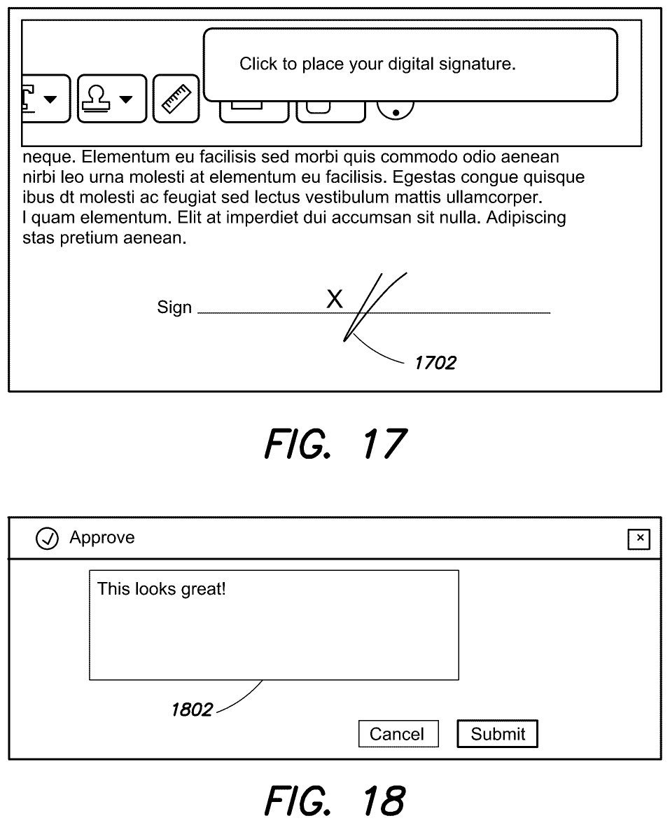

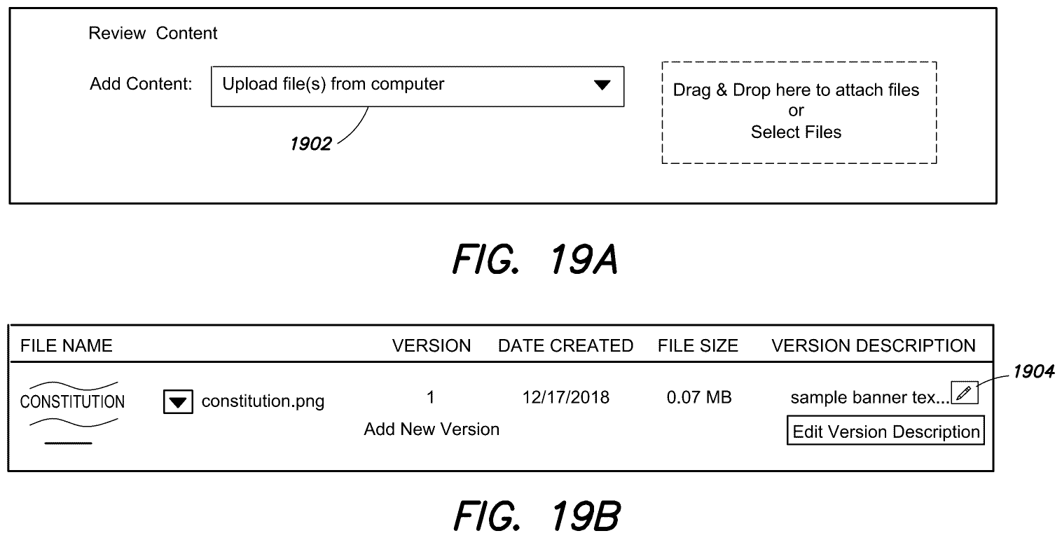

Files may be selected for review in several different ways. In some embodiments, a review may include several different files and the different files may be uploaded in different ways. An exemplary option is to upload one or more files from a user's computer, as illustrated in FIG. 19A. With this option, a user may select one or more files to upload 1902 from the user's computer, network, or another folder, or may drag and drop files into the window to upload them. In some embodiments, a smaller image (e.g., a low-resolution PDF of screenshot) may be created for the purpose of review to avoid the delay associated with uploading extremely large-scale PDFs (e.g., billboards, large posters). For example, a 60″ image at 300 DPI print resolution creates an 18,000-pixel image which may be difficult for servers to convert and browsers to handle.

Another exemplary option is to specify a Universal Resource Locator (URL) with annotation for a website to be reviewed. In some embodiments, a screenshot of a website identified by the URL is added to the Review. In some embodiments, the inside pages of the URL will be added to the Review when the option to Annotate entire website is checked. Another exemplary option is to specify a URL without annotation for a website to be reviewed. With this option, general comments and feedback about the URL and record approval decisions may be captured. This option may be used for review of an internal URL (i.e., not accessible via the general internet), a YouTube video, a Vimeo video, or content on other 3rd-party web sites.

Another exemplary option that may be used is Add website as Zip for uploading a zipped archive of a web site. With this option, the main page, graphics, HTML and all images are extracted, and the web page may be viewed for annotation and approval. Another exemplary option that may be used is Upload zip and extract file(s) for uploading a zipped archive of several files for review all at once. For example, 20 different design ideas for a logo may be uploaded at the same time by adding them to a ZIP archive, and uploading them as the Zip archive. In some embodiments, the separate images for the logos may be extracted for review. Another exemplary option that may be used is Add file(s) from Project: for uploading one or more files that already exist anywhere within a project. Another exemplar option is Add file(s) from Library for uploading a file that already exists anywhere in the folder structure of the “Library” tab.

In some embodiments, a description, or version label, may be added to each version of a review file for identifying different review categories, types, or a descriptor other than the file name itself. In some embodiments, a version label may be added or edited on the Create/Modify Review screen by selecting an icon to the right of each file as illustrated in FIG. 19B. In some embodiments, files are converted to a JPEG image or series of image for annotation.

Exemplary file types that may be uploaded for annotation are listed below:
Image files: jpg, jpeg, png, gif psd, tif tiff, ai, eps, ps, bmp, cr2, dng, tga, pgm, ppm, are, svg
Document files
Text: pdf, doc, docx, rtf, txt, odt
Spreadsheet: xlsx, xls, csv
PowerPoint: ppt, pptx
Video files: mpg, mov, mp4, 3gp, ogg, ogv, webm, flv
Email files: eml, msg
Other file types: zip, html, htm

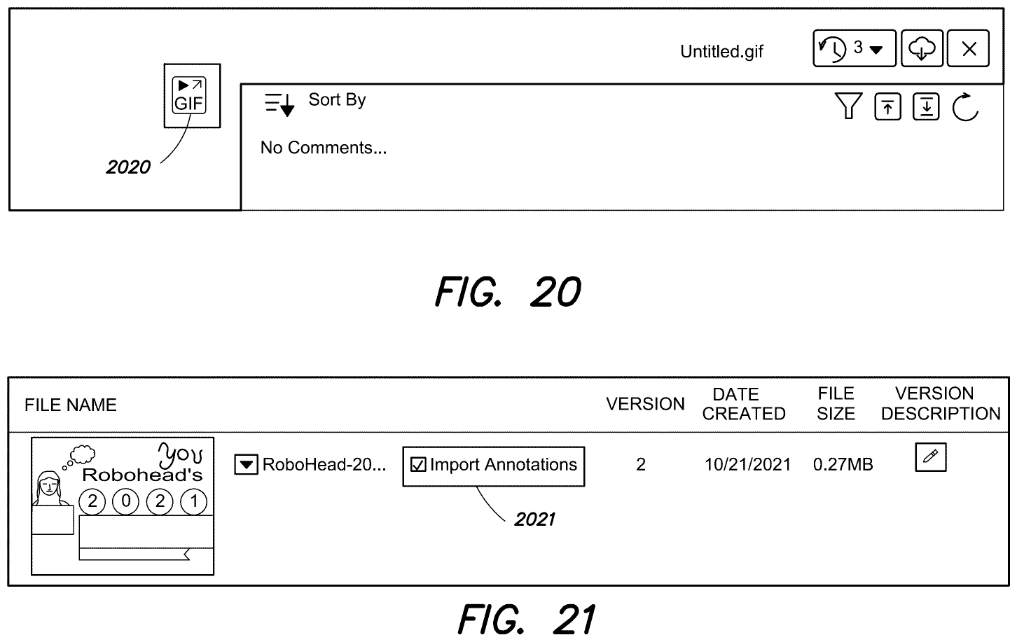

In some embodiments, video files (e.g., H.264 MP4 format) may be uploaded for review and annotation. In some embodiments, animated GIF files 2002 may be uploaded for review and annotation, as illustrated in FIG. 20. Animations may be viewed by clicking an icon in the upper-right corner of the review screen. In some embodiments, pdf annotations may be imported from a PDF reader (e.g., Adobe Acrobat/Reader) using the Import Annotations option 2021, as shown in FIG. 21. A user may see annotations by checking the Import Annotations option on the Review Page. Various annotation types by be imported including: Polygon, Polyline, Highlight, Underline, Strikethrough, Caret (Text Insert), Text replace, Line, Arrow, Ellipse (Oval shape), Distance, Cloud, and Stamp. In some embodiments, if a stamp in a pdf file matches a stamp within the system of the present invention, it will be imported as a stamp. Otherwise, the import will render as a “spot” comment at the specific coordinate of the file. In some embodiments, any unsupported annotation types may be added as notes. Annotations/comments imported from an uploaded PDF may display the author as a generic name (e.g., “PDF Import”) rather than the name of an actual user. In some embodiments, the author is the user who uploaded the file. If the user is signed into Adobe Acrobat/Reader when making the annotations, for example, the name of the person who added the annotation/comment in Acrobat/Reader may be imported as part of the comment.

In some embodiments, a sequential/Multi-Stage Review may be arranged. In a Sequential, or multi-stage Review, routes may be set for Review through different reviewers or Review Groups automatically. For example, a document may first need to be reviewed by a Brand Team, followed by a Legal Department and finally, Management for final sign-off. To create a sequential review, a user may select the New Review option and complete the various fields (e.g., Review name, Review type, Review owners, and Review status). Next, under the Reviewers & Notifications header, the Set up multi-stage review option may be selected. In some embodiments, a user may specify when each stage should start. In some embodiments, the Comments/Feedback and Approval Reviews for subsequent stage may have different options that those for the first stage.

Exemplary subsequent stages for a Comments/Feedback review include:
ALL reviewers have Finished—Starts this stage when all users included in the Reviewers field have clicked the “I'm Finished” button
ANY reviewers have Finished—Starts this stage when ANY reviewers have clicked “I'm Finished.” Good for Reviews where only one approver of those included needs to respond.
After due date of previous stage—Starts this stage of the Review when the due date of the previous stage arrives regardless of approvals.
Review Owner starts this stage—Starts this stage when any Review Owner(s) manually initiate the stage. Requires manual activation.

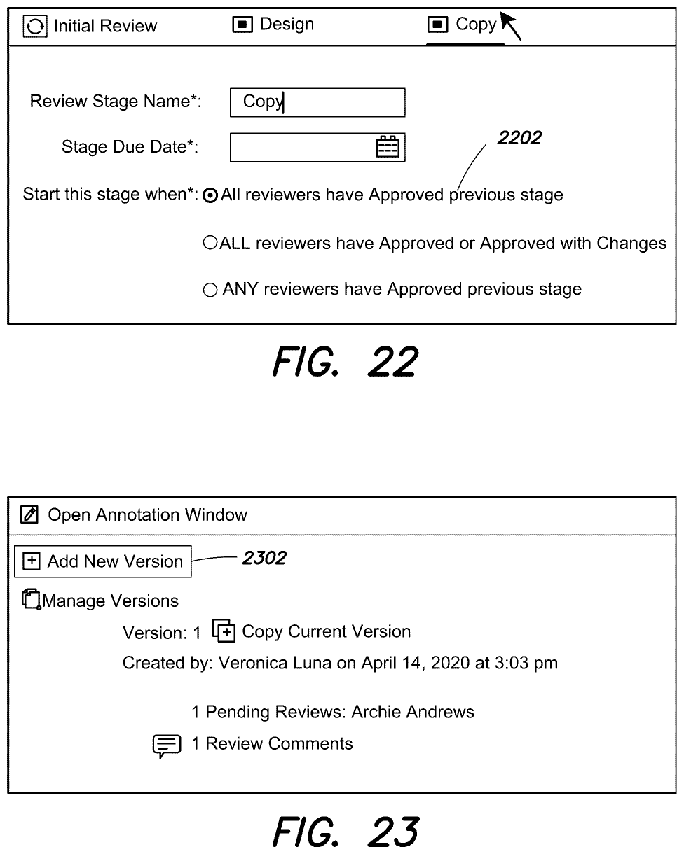

Exemplary subsequent stages for a Request Approval Review may include:
ALL reviewers have Approved—Starts this stage when all reviewers have selected the Approved button in the Review. Will not activate with Approved with Changes selections.
ALL reviewers have Approved or Approved with Changes—Starts this stage when reviewers have selected Approved OR Approved with Changes.
ANY reviewers have Approved—Starts this stage when any reviewers have selected Approved.
ANY reviewers have Approved or Approved with Changes—Starts this stage when any reviewers have selected Approved OR Approved with Changes.
After due date of previous stage—Starts this stage of the Review when the due date of the previous stage arrives regardless of approvals.
Review Owner starts this stage—Starts this stage when any Review Owner(s) manually initiate the stage. Requires manual activation.
   After the review stages are configured, each stage may proceed like a normal review upon starting in accordance with the specified conditions. A user may re-organize or delete stages that have not started at any point during the review process. A user may delete or add a stage by clicking on a dropdown menu next to the stage before the spot where the new stage is to be added and each stage may be dragged to the desired spot, as illustrated in FIG. 22. A user may decide when to start the new stage by selecting different options such as “When all reviewers have Approved previous stage” 2202.

In some embodiments, different versions of review files may be uploaded and managed. A Review file may be uploaded by navigating to the Reviews tab within an existing Project and selecting on a Review by clicking on its name. A View Review screen will then be displayed. A user may then select the Review Actions dropdown menu and select Modify Review. Next, a user may select the Add new version option. Changes may then be made to the new version of the review such as adding new Reviewers or modifying the Due Date. A user will then be asked whether to send an Email Notification to the Reviewers letting them know a new version was added.

In some embodiments a new version of a review file may be created by selecting a symbol near an existing Review Item's image and selecting the Add New Version option 2302, as illustrated in FIG. 23. In some embodiments, when a user adds a new file or new file version to a review, the user will be warned if the review is in an inactive state and will be allowed to choose whether to activate the review 2402, as illustrated in FIG. 24.

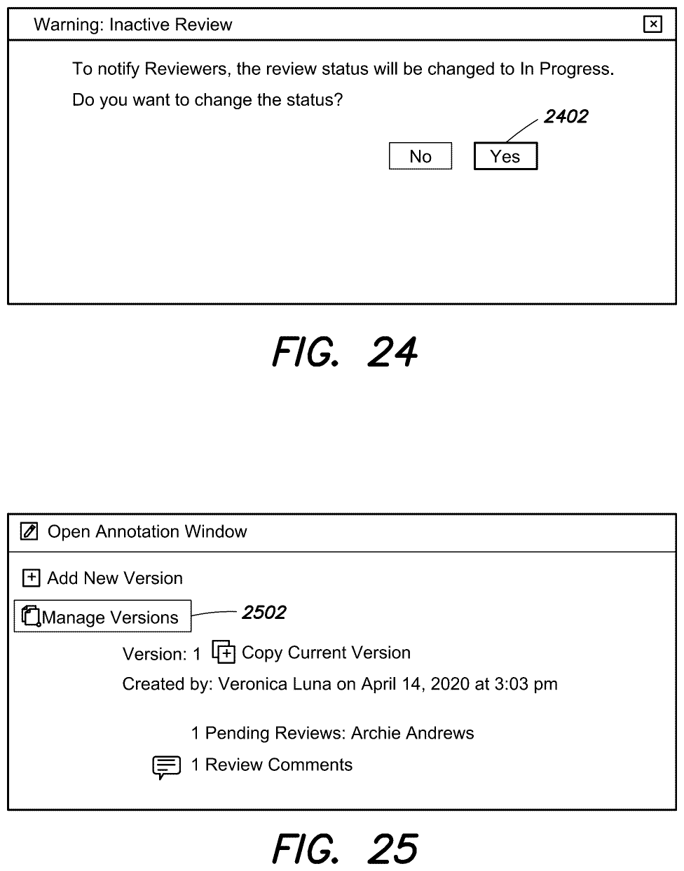

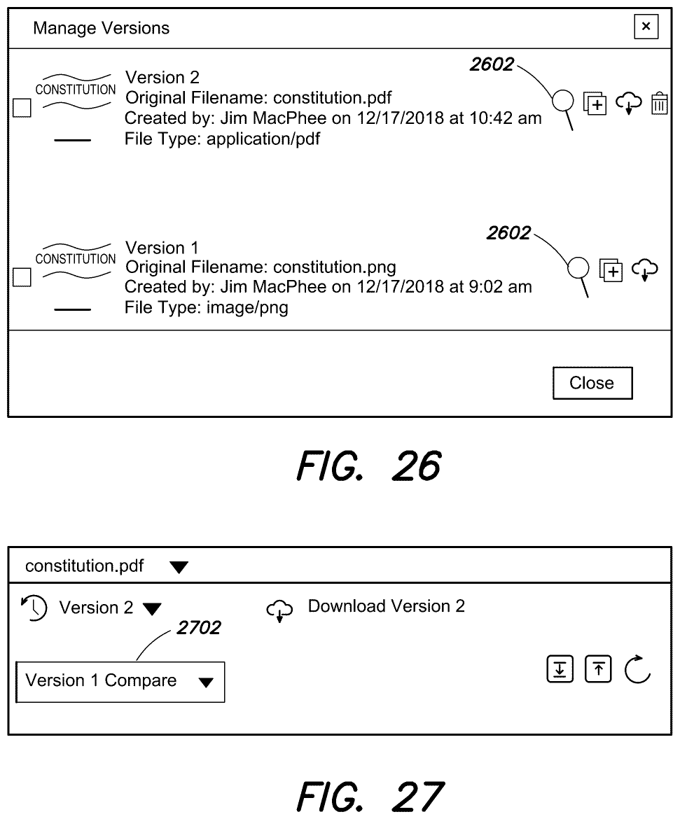

In some embodiments, a user may select a Version of a Review, either in an annotation tool or on the View Review screen. A user may also compare any two versions of a review side-by-side, to see if changes/edits were made, or to see the differences between two documents. In some embodiments, a user may select a version by clicking the Manage Versions option 2502 on the View Review screen, as illustrated in FIG. 25. A magnifying glass symbol 2602 may be selected to choose the desired version to open, as illustrated in FIG. 26. In some embodiments, a user may select a version using the Version dropdown menu in an Annotation window.

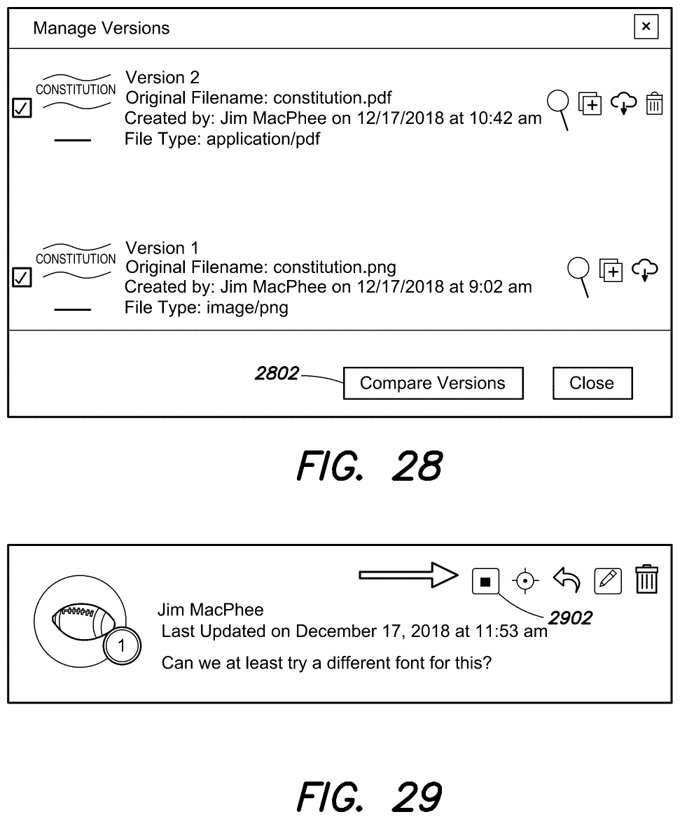

In some embodiments one version of a Review file may be compared to another version side-by-side. This is useful for making changes and tracking what changes are complete from version to version. To compare two versions, a user may open the annotation tool by clicking on the desired review file, clicking the version dropdown menu on the Review page, selecting a version, and selecting the Compare option 2702, as illustrated in FIG. 27. A split screen view will then appear with the selected versions displayed side by side. In some embodiments, annotations may be added or edited to a version in the split screen view. Comments may be shown or hidden by clicking symbols such as small arrows. The annotation panel may be closed for one of the versions on the split screen view by clicking on a symbol such as a small “x” near the name of the version file. Two versions of a Review may be selected for comparison by selecting Manage Version near the Review and then selecting Compare Versions 2802, as illustrated in FIG. 28.

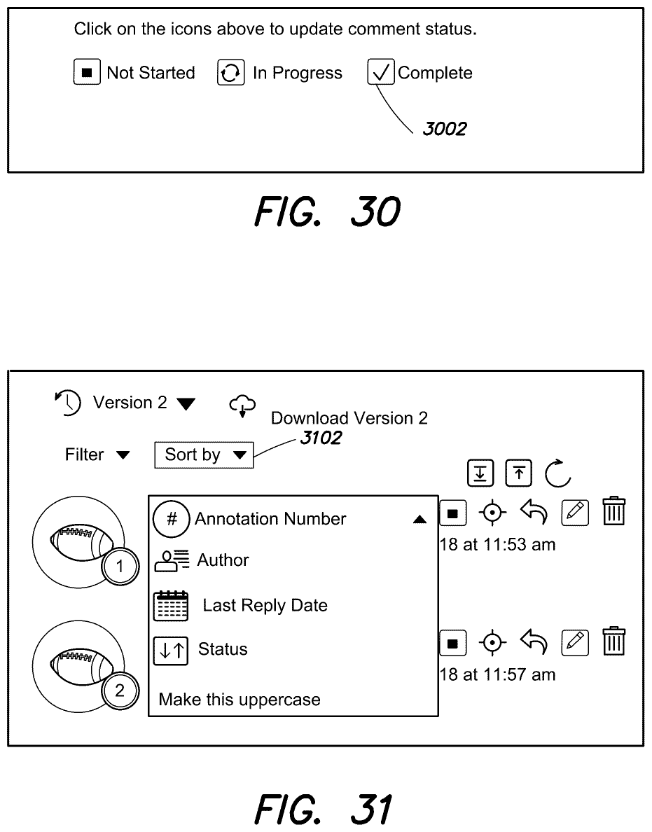

In some embodiments, a Review Annotation tool may be used to track comment/change progress and completion of a Review. Users with Contribute or Manage access to a Project may track comment progress with a checkbox system 2902, as illustrated in FIG. 29. This feature provides Designers or those responsible for making changes as the result of a Review, the ability to track changes that are not started, in progress, or complete. A checkbox adjacent to a particular annotation may be updated to clicking on it once to mark the annotation as In Progress and clicking on it a second time to mark it as Complete 3002, as illustrated in FIG. 30. If the wrong option is selected, a user may repeatedly click on the checkbox to select the correct option. In some embodiments, a legend at the bottom of the annotation list shows each option and its associated graphic. In some embodiments, Reviewers with View access to a Project, as well as Contacts, are able to view the comment progress boxes and the status of each, so they are aware of the progress of comments they have made.

In some embodiments, comments may be sorted and filtered on an annotation panel by any user (e.g., Review Manager, Review Owner, or Reviewer) using various criteria. To sort comments, the Sort By option 3102 may be selected at the top of an annotation list, as illustrated in FIG. 31. Sorting may be done with respect to various criteria (e.g., numerically by annotation number, alphabetically by the Author of each comment, Last Reply date, or Status). Because comments are numbered in the order in which they are added, sorting by annotation number sorts the list of comments by their creation date.

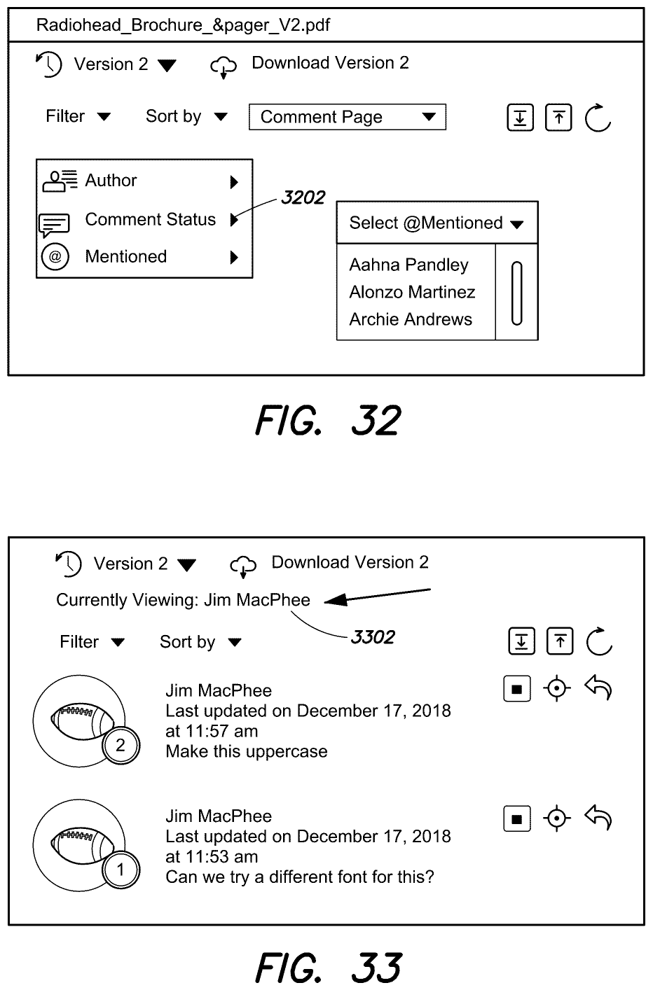

In some embodiments, comments may be filtered by first selecting the Filter option and then choosing the criteria upon which to filter (e.g., author, or comment status), as shown in FIG. 32. This feature allows a user to view, for example, comments made by specific individuals, comments with certain status values, or comments that mention specific users. For example, a designer may wish to filter comments with a Not Started or In Progress status value in the Comment Status field 3202 to view only those comments that have been completed or resolved. In some embodiments, a filter may be removed.

In some embodiments, users who are currently viewing a Review file with the annotation tool may be displayed, as illustrated by FIG. 33. This feature is helpful for seeing multiple users who may be making comments on a Review at the same time to thereby allow them to collaborate in real time (e.g., via a conversation) and for seeing the users that are viewing a particular user's comments. In some embodiments, the list of viewers in the Currently Viewing area 3302 will be empty when only one user is viewing the Review file.

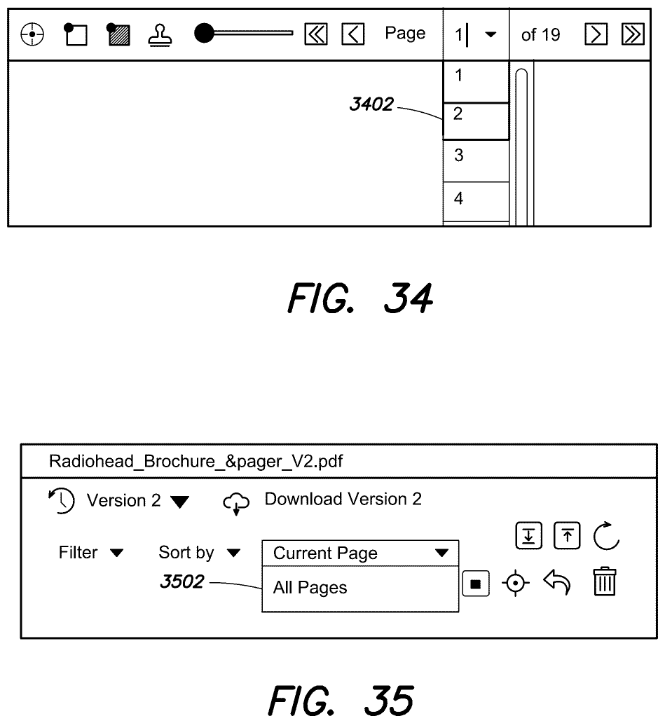

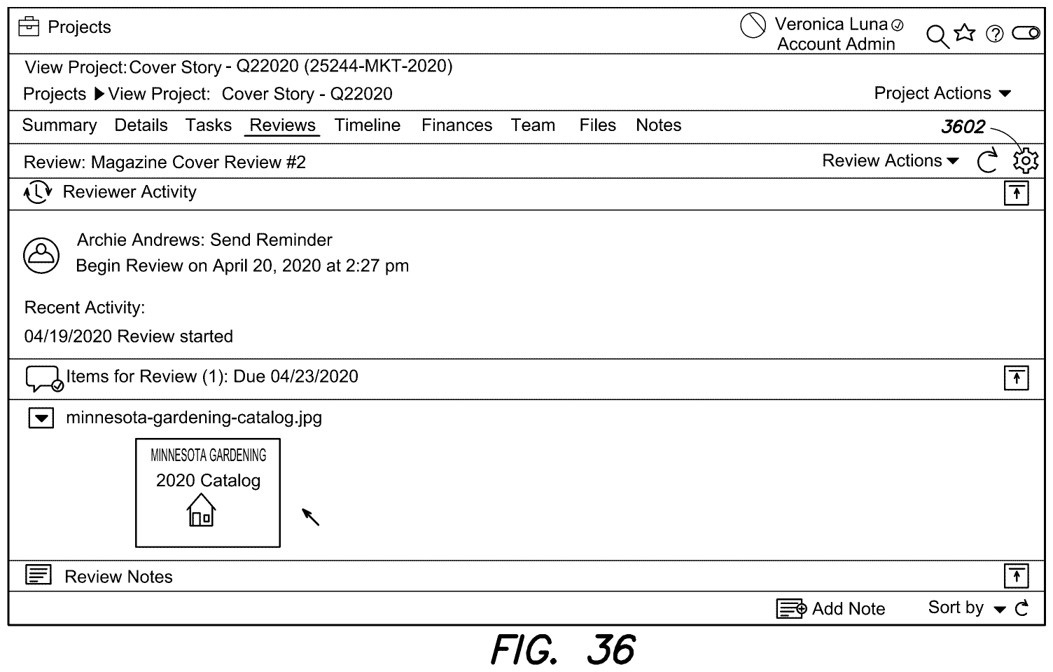

In some embodiments, Reviewer annotations may be found and replies to annotations may be made. For multi-page documents, pages with comments may be highlighted in a page-list drop-down menu 3402, as illustrated in FIG. 34. In addition, all comments in a multi-page document may be viewed at once by choosing the All Pages option 3502, as illustrated in FIG. 35. Replies to comments from a reviewer may be made for a Review by selecting the Reply link in an annotation/markup window. If the option to Notify Comment Author on Reply was selected when a Review was created, a reviewer will when an answer or reply is received to a question or comment respectively. In addition, overall or general review notes may be made (e.g., for multiple files) in a Review without using an annotation tool by navigating to the Review page and selecting the Add Note option. In some embodiments, a list of such Review Notes that have been made by users will be displayed.

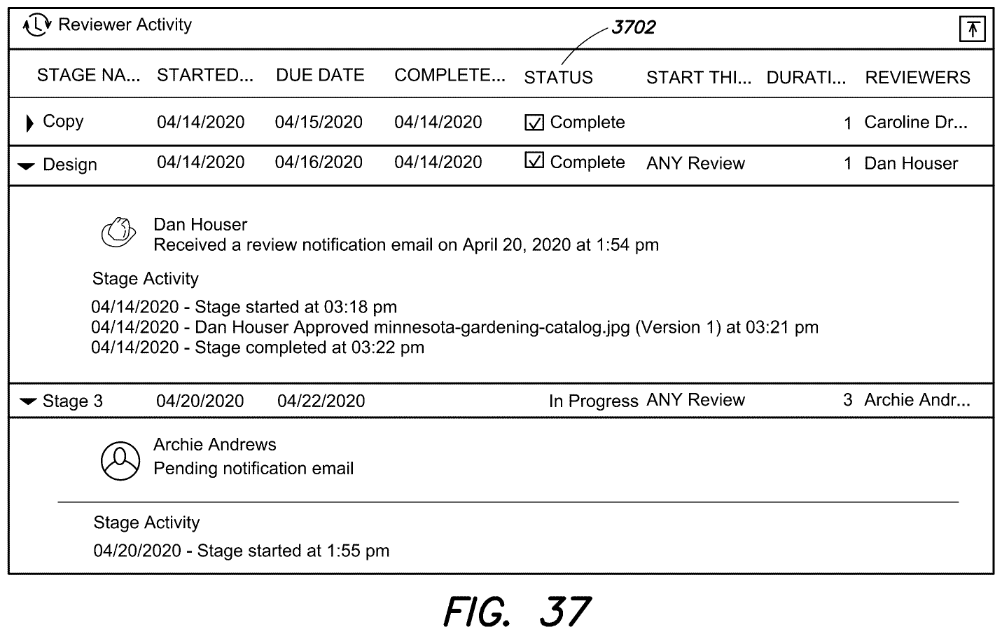

A Review screen may be configured by selecting the gear icon 3602 and ordering the selections, as illustrated in FIG. 36. In addition, Review status and Reviewer progress may be monitored and tracked in a Reviewer Activity box for a Review, as illustrated in FIG. 37. Each stage of the Review may be expanded to see the status for that stage. In some embodiments, a variety of different indicators may represent the Review Status and Reviewer progress. For example, the status for different stages of a review may appear in a column and the different stages of a review may be sorted by their status. In some embodiments, the screen with the Review status and Reviewer progress may be refreshed to get updates for the Reviews. The Review status and progress field 3702 may contain one or more of the following values:
Not Ready: Initial progress (When the Review is Created).
File not Uploaded: A Review is created, but a file has not been uploaded into the Review yet.
File Processing Failed: If any of the Review files fail in processing. There could be several reasons for this, please contact RoboHead Support if this occurs.
File Processing Complete: When the file has finished processing for annotation, but e-mail notifications have not yet been sent to Reviewer(s). This would only happen if the start date of the review is in the future, or the Review email notifications are undeliverable.
Reviewers Notified: Notification email to Reviewer(s) has been sent.
Pending: Awaiting Reviewer Comments/Feedback/Approval
Complete: The entire Review was marked Complete by a Review Owner.

The Reviewer status field may contain one or more of the following values:
Pending Notification: The Review has been created, but notifications have not yet been sent (Start date not yet arrived, or files not added yet to Review).
Email Received: Review Notification email has been sent to Reviewer(s).
Began Review: Reviewer has added at least one annotation/comment to the Review.
Approved: The reviewer has approved all the latest version(s).
Rejected: The reviewer has rejected the latest version(s).
Approved with Changes: Reviewer has approved the latest version(s) with Changes.
Complete: The Review Type is Comments/Feedback, and the Reviewer marked the Review as Finished.

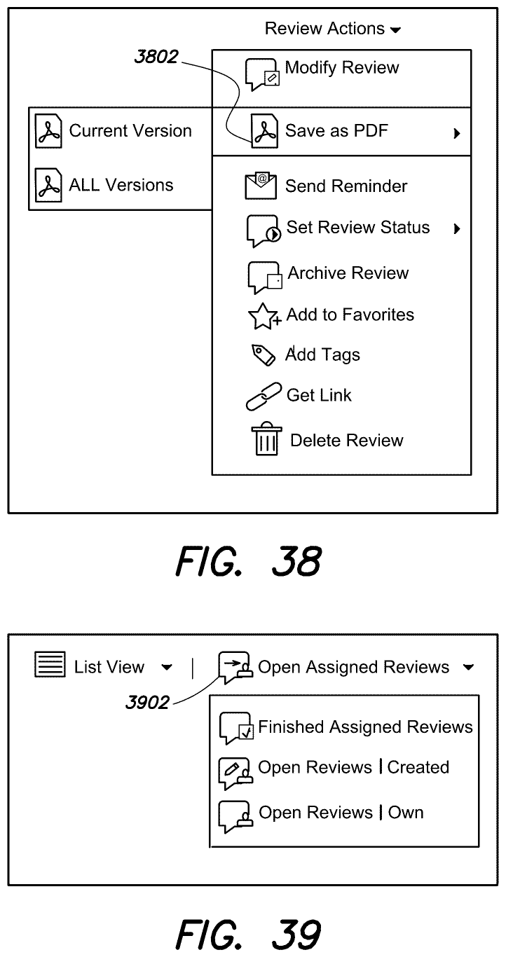

Review reminders may be sent to Reviewers via email who has not yet responded to a Review to prompt them to perform their reviews by selecting a Send Reminder option under Reviewer Status on a Review Summary page, as illustrated in FIG. 38. In some embodiments, a review may be saved as a PDF by selecting Review Actions followed by Save as PDF 3802 on the View Review screen. The resulting PDF file may contain various types of information such as Reviewer/Approver status, information, and approval decisions made. Each page of a Review, along with a list of comments, may be displayed. The resulting PDF file may be printed.

A process for a Review may be designated as being completed when all reviewers have finished reviewing or have submitted their approvals, by changing the status of the Review to Complete. This will turn off all alerts related to the review, and reviewers will no longer see the review anywhere on their Reviews tab. Although it is still possible to upload a new version of the Review and make comments on the new version, reviewers will not receive notifications on a Review that has been designated as Complete unless the status is changed back to In Progress. If a Review passes the Due Date, it will still be available to reviewers until the status is marked Complete. The purpose of the Due Date is to let reviewers know when the review is due. In some embodiments, the status of the Review may be changed to Complete Automatically if the Autocomplete Review option was selected on the Modify Review screen.

In some embodiments, different categories in the Review may be selected, as illustrated in FIG. 39. The categories include the following:
Open Assigned Reviews 3902: this is the list of Reviews you look at as a Reviewer.
Finished Assigned Reviews: this is the list of Reviews you have finished, or given an approval decision on.
Open Reviews I Created: this is the list of reviews you have created yourself, where the Review Status is not yet one of the ‘Complete’ options.
Open Reviews I Own: this is the list of reviews you are listed as the owner of (you are managing the Review, or have some role in the management of the review).
   The Open Review I Created category may also contain the same Reviews as the Open Reviews I Own category because Review Creators are Review Owners by default and will remain so unless changed. Reviews that are set to a Complete status disappear from the Reviews tab for each user associated with the Review. In some embodiments, files from the Finished/Approved Review may be copied to a Project Library and marked as Final Deliverables to thereby expand Portfolios without any additional input.

In some embodiments, a review may be hidden or suspended without deleting by archiving it in a similar way as a project is archived by selecting Archive Review option on the Review Actions menu. All notifications concerning an archived review will be suspended until it is changed from archived to active.

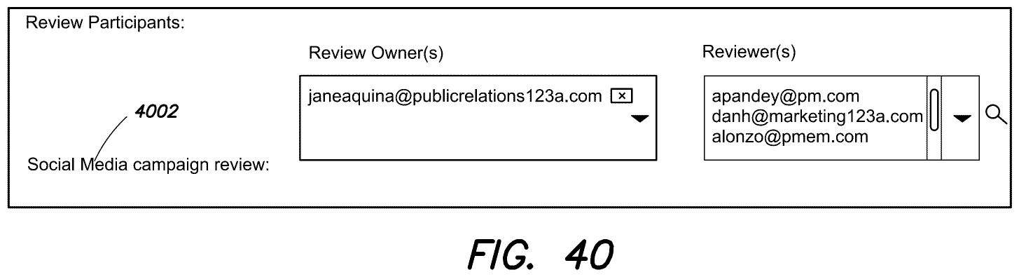

In some embodiments, a review may be integrated into a project template by initially specifying the only the review name such as the Social Media campaign review 4002, as illustrated in FIG. 40. The remaining information for a review may be completed after the template is applied to a project. A decision as to which users will act as owner and reviewers may be made at the time of template assignment.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system for collaboration among a plurality of users on three-dimensional digital media development comprising:
an interface comprising a plurality of display elements, the display elements being configured to:
display a control enabling a first one of the plurality of users to select a file containing at least one three-dimensional object to upload;
receive information for at least one review including an assignment of the at least one three-dimensional object to the at least one review;
display a control enabling a second one of the plurality of users to perform one or more operations on the at least one three-dimensional object, the operations including rotating and scaling; and
receive one or more annotations on one or more locations of the at least one three-dimensional object.

2. The system for collaboration among a plurality of users on three-dimensional digital media development according to claim 1, wherein the display elements are further configured to:
display a control enabling the second one of the plurality of users to select a file containing at least one three-dimensional animation to upload;
display a control enabling the second one of the plurality of uses to perform one or more operations on the at least one three-dimensional animation, the operations including rotating, scaling, starting, stopping, and resuming the at least one three-dimensional animation;
receive an assignment of the at least one three-dimensional animation to the at least one review; and
receive one or more annotations at one or more locations on the at least one three-dimensional animation at one or more instances in time.

3. The system for collaboration among a plurality of users on three-dimensional digital media development according to claim 1, wherein the display elements are further configured to:
receive information for the at least one project; and
receive information for the at least one review.

4. The system for collaboration among a plurality of users on three-dimensional digital media development as in claim 3 wherein:
the information for the at least one project includes at least one of the group comprising a title, a status, budgeted expenses, revenue, expenses, a code, a description, estimated revenue, the name of a creator of the at least one project, a planned start date, an indicator of whether the at least one project is on budget, a due date, an identifier, an indicator of whether the at least one project is on schedule.

5. The system for collaboration among a plurality of users on three-dimensional digital media development according to claim 3, wherein:
the information for the at least one review includes at least one of the group comprising a name, a type, a name of an owner of the at least one review, a status, a start date, an end date, an indicator of whether the at least one review is automatically completed, and one or more predecessors.

6. The system for collaboration among a plurality of users on three-dimensional digital media development according to claim 1, wherein the at least one review comprises a plurality of stages and wherein the display elements are further configured to:
receive information for at least one of the plurality of stages, the information including one or more of the group comprising a name, a due date, a name of an owner of the at least one of the plurality of stages, an indicator of whether to notify the owner of a response for the at least one of the plurality of stages, one or more email addresses designated to receive that at least one of the plurality of stages; and
notify the owner of the response for the at least one of the plurality of stages.

7. The system for collaboration among a plurality of users on three-dimensional digital media development according to claim 1, wherein the at least one three-dimensional object comprises a plurality of versions and the plurality of display elements is further configured to:
display a first one the plurality of versions of the at least one three-dimensional object on a screen with a second one of the plurality of versions of the at least one three-dimensional object; and
compare the first one of the plurality of versions of the at least one three-dimensional object with the second one of the plurality of versions of the at least one three-dimensional object.

8. The system for collaboration among a plurality of users on three-dimensional digital media development according to claim 1, wherein the plurality of display elements is further configured to:
receive one or more comments on one or more locations of the three-dimensional object.

9. The system for collaboration among a plurality of users on three-dimensional digital media development according to claim 2, wherein the plurality of display elements is further configured to:
receive one or more comments on the one or more locations of the three-dimensional animation at the one or more instances in time.

10. The system for collaboration among a plurality of users on three-dimensional digital media development according to claim 1, wherein the plurality of display elements is further configured to:
receive an approval of the three-dimensional object from the second one of the plurality of users.

11. A method for collaboration among a plurality of users on three-dimensional digital media development comprising:
displaying a control enabling a first one of the plurality of users to select a file containing at least one three-dimensional object to upload;
receiving information for at least one review including an assignment of the at least one three-dimensional object to the at least one review;
displaying a control enabling a second one of the plurality of users to perform one or more operations on the at least one three-dimensional object, the operations including rotating and scaling; and
receiving one or more annotations on one or more locations of the at least one three-dimensional object.

12. The method for collaboration among a plurality of users on three-dimensional digital media development according to claim 11 further comprising:
displaying a control enabling the second one of the plurality of users to select a file containing at least one three-dimensional animation to upload;
displaying a control enabling the second one of the plurality of uses to perform one or more operations on the at least one three-dimensional animation, the operations including rotating, scaling, starting, stopping, and resuming the at least one three-dimensional animation;
receiving an assignment of the at least one three-dimensional animation to the at least one review; and
receiving one or more annotations at one or more locations on the at least one three-dimensional animation at one or more instances in time.

13. The method for collaboration among a plurality of users on three-dimensional digital media development according to claim 11, further comprising:
receiving information for the at least one project; and
receiving information for the at least one review.

14. The method for collaboration among a plurality of users on three-dimensional digital media development as in claim 13 wherein:
the information for the at least one project includes at least one of the group comprising a title, a status, budgeted expenses, revenue, expenses, a code, a description, estimated revenue, the name of a creator of the at least one project, a planned start date, an indicator of whether the at least one project is on budget, a due date, an identifier, an indicator of whether the at least one project is on schedule.

15. The method for collaboration among a plurality of users on three-dimensional digital media development according to claim 13, wherein:
the information for the at least one review includes at least one of the group comprising a name, a type, a name of an owner of the at least one review, a status, a start date, an end date, an indicator of whether the at least one review is automatically completed, and one or more predecessors.

16. The method for collaboration among a plurality of users on three-dimensional digital media development according to claim 11, wherein the at least one review comprises a plurality of stages, the method further comprising:
receiving information for at least one of the plurality of stages, the information including one or more of the group comprising a name, a due date, a name of an owner of the at least one of the plurality of stages, an indicator of whether to notify the owner of a response for the at least one of the plurality of stages, one or more email addresses designated to receive that at least one of the plurality of stages; and
notifying the owner of the response for the at least one of the plurality of stages.

17. The method for collaboration among a plurality of users on three-dimensional digital media development according to claim 11, wherein the at least one three-dimensional object comprises a plurality of versions, the method further comprising:
displaying a first one the plurality of versions of the at least one three-dimensional object on a screen with a second one of the plurality of versions of the at least one three-dimensional object; and
comparing the first one of the plurality of versions of the at least one three-dimensional object with the second one of the plurality of versions of the at least one three-dimensional object.

18. The method for collaboration among a plurality of users on three-dimensional digital media development according to claim 11, further comprising:
receiving one or more comments on one or more locations of the three-dimensional object.

19. The method for collaboration among a plurality of users on three-dimensional digital media development according to claim 12, further comprising:
receiving one or more comments on the one or more locations of the three-dimensional animation at the one or more instances in time.

20. The method for collaboration among a plurality of users on three-dimensional digital media development according to claim 11, further comprising:
receiving an approval of the three-dimensional object from the second one of the plurality of users.

21. A non-transitory computer-readable media comprising instructions that, when executed by one or more processors on a computing device, are operable to cause the one or more processors to execute the method of claim 11.
